(19) United States
(12) Patent Application Publication
(10) Pub. No.: US 2005/0170776 A1
(43) Pub. Date: Aug. 4, 2005

(54) Wireless technology co-existence

(76) Inventor: David Siorpaes, Cortina D'Ampezzo (IT)

Correspondence Address: PHILIPS INTELLECTUAL PROPERTY & STANDARDS, P.O. BOX 3001, BRIARCLIFF MANOR, NY, 10510, US

(21) Appl. No.: 10/516,549

(22) PCT Filed: May 21, 2003
(86) PCT No.: PCT/IB03/02261

(30) Foreign Application Priority Data
Jun. 7, 2002 (EP) 02077283.6

(51) Int. Cl. H04B 7/00

(52) U.S. Cl. 455/41.2; 455/501

(57) ABSTRACT

Multi-mode hardware that supports both Wireless LAN and Wireless PAN standards in the 2.4 Ghz ISM band are becoming available. This invention discloses a multi-standard wireless driver that includes a Multi-standard Wireless Adaptation Layer (M-WAL) with the capability to efficiently handle concurrent operation of multiple wireless transceivers while reducing mutual interference and matching application traffic requirements. The multi-standard Wireless Adaptation Layer is a virtual device driver that is not limited to networking applications but also takes other application profiles into account, such as those described in the Bluetooth standard.

### FIELD OF THE INVENTION

The present invention relates to wireless technology co-existence and in particular, but not exclusively, to co-existence in scenarios requiring the ability for at least two wireless technologies to operate substantially simultaneously within the same band.

### BACKGROUND TO THE INVENTION

It is known that attempts to operate two or more wireless technologies can lead to problems in achieving substantially interference free co-existence. By co-existence is meant the ability to co-locate in an operational environment a plurality of wireless systems without significant impact of any one or more on the performance of another. These problems are particularly acute if two or more of the systems are to operate within the same band.

Some current devices such as laptops already embed multiple wireless interfaces such as IEEE802.11b and Bluetooth, for example to connect to local area networks and to peripherals. While IEEE802.11b only supports networking applications typically based on the Internet Protocol (IP) and exports an Ethernet interface, the case of Bluetooth is different. In fact, this standard does not only support networking applications by means of the Personal Area Network (PAN) profile, but also point-to-point services like object exchange, synchronization, printing or connection to peripheral devices. It is known to use IEEE802.11b and Bluetooth wireless interfaces concurrently for different purposes in some user devices.

Since both IEEE802.11b and Bluetooth standards use the 2.4 GHz ISM band in an uncoordinated manner, whenever a collision in the time and frequency axes occurs, the MAC layers trigger frame retransmissions, which can result in reduced throughput in both systems. It is therefore desirable to introduce suitable means to limit such mutual interference effects and favor coexistence of the two standards while preferably also matching application traffic requirements.

Thus, with the advent of for example WPAN and WLAN as complementary technologies, co-location of Bluetooth and IEEE802.11 (i.e. “Wi-Fi”) devices is becoming an area for significant potential growth. The problems involved need to be addressed as more multi-standard hardware and software becomes available, e.g. on combination chipsets for portable devices such as Personal Digital Assistants (PDAs), lap-top computing devices and mobile communications devices.

Solutions to co-existence of the Bluetooth and the IEEE802.11b standards in the ISM band have been proposed, some in the IEEE802.15.2 and Bluetooth SIG Coexistence working groups. Many solutions proposed can be categorized into: 1) modifications of the MAC layers (for example adaptive frequency hopping); 2) coordination of peer devices; and 3) driver-level switching. A useful discussion of some the issues and problems involved and general state of the art can be found in at least the article:

“Wi-Fi (802.11b) and Bluetooth: Enabling Co-existence”; Jim Lansford, Adrian Stevens and Ron Nevo of “Mobilan Corporation”, IEEE Network, September/October 2001.

One particular prior art proposal is disclosed in EP-1119137, in which an interoperability device resides below the device drivers and has the capability of switching on and off the radio modules. This is intended to eliminate interference by controlling radio module activity in an appropriate way and implies that the interoperability device has full control over both IEEE802.11 MAC and Bluetooth baseband and is capable of knowing whether or not a radio module is transmitting or receiving at any given time. To implement this, the arrangement of EP-1119137 requires extra channels and associated custom hardware and software is therefore required to implement the proposal.

### SUMMARY OF THE INVENTION

It is an object of the present invention to provide an improved arrangement for co-existence of a plurality of wireless technologies and in particular, but not exclusively, an improved arrangement for co-existence of a plurality of wireless technologies that operate in the same band, e.g. Bluetooth and IEEE 802.11 technologies.

Accordingly, the present invention provides a device incorporating a first communications arrangement adapted to operate in accordance with a first communications standard and a second communications arrangement adapted to operate in accordance with a second communications standard, at least a portion of a range of operation of said first and second communications standards being in use in an overlapping relationship, said device having a protocol architecture including at least one of software implemented driver-level switching and dynamic parameter control adapted to ensure that there is substantially no mutual interference between communications at said device under either of said first and second communications standards.

Said driver level switching may avoid said mutual interference through the application of a scheduling policy to transmissions under each said communications standard.

Said scheduling policy may be adapted to place said transmissions in a queue and to control said queue such that transmissions under one of said communications standards do not collide with transmissions under the other communications standard Said scheduling policy may comprise a time-share mechanism adapted to apply predetermined percentages of time to transmissions made under each said communications standard.

A duty cycle of said scheduling policy may be dynamically varied according to the characteristics of communications traffic under each said standard.

Said communications standards may comprise wireless communications standards and said software may be implemented in the form of a wireless adaptation layer.

Said software may further comprise a quality-of-service arrangement adapted to schedule transmission under said communications standards according to application requirements.

Schedulers of each communications standard may communicate with each other, such that each one knows when a channel is taken by a communication from the other and refrains from transmitting, said schedulers preferably communicating at Medium Access Control (MAC) level. Policies for said schedulers may be set in accordance with channel state or traffic information.

Communications under a said standard may be performed at least temporarily using a reduced bandwidth, such that communications under the other said standard substantially do not overlap.

Said communications may comprise packet transmissions. Said communications standards may comprise Bluetooth and IEEE 802.11.

An operating parameter, such as one or more of packet fragmentation, variable transmission power and variable data rate, may be activated by said software only when it is determined that it is required, such determination preferably being based on traffic characteristics. Collision avoidance between said communications standards may be implemented in Bluetooth hardware or firmware. Said device may comprise one of a client device, a master unit, a slave unit or an access point.

The present invention also provides a method of implementing co-existence of a plurality of communications arrangements operating under communications standards having at least partially overlapping bandwidths, the method including implementing, in software at driver level in a protocol stack, a driver level switching arrangement adapted to ensure that there is substantially no mutual interference between communications under said communications standards.

The present invention also provides a software product having encoded thereon executable code for implementing co-existence of a plurality of communications arrangements operating under communications standards having at least partially overlapping bandwidths, the software product including code for implementing, at driver level in a protocol stack, a driver level switching arrangement adapted to ensure that there is substantially no mutual interference between communications under said communications standards.

### BRIEF DESCRIPTION OF THE DRAWINGS

FIG. 1 is a schematic diagram of a communications network incorporating multi-standard wireless technology co-existence in accordance with an embodiment of the invention;

FIG. 2 is a diagram of Bluetooth profiles; and

FIG. 3 is a block diagram of software architecture used to implement an embodiment of the present invention.

### DETAILED DESCRIPTION OF A PREFERRED EMBODIMENT

The present invention will now be described with reference to certain embodiments and with reference to the above mentioned drawings. Such description is by way of example only and the invention is not limited thereto. In particular the present invention will be described with reference to radio communications network but the present invention is not limited thereto. The term “wireless” should be interpreted widely to cover any communications system that does not use fixed wireline communications for some of its transmissions. It should also be noted that the term “wireless” also includes so-called cordless systems. General aspects of cordless communications systems are described for instance in the book by W. Tuttlebee, “Cordless Telecommunications Worldwide”, Springer, 1997. Cordless systems are generally local, uncoordinated radio communications networks having a limited range.

Further, the present invention will be described mainly with reference to a local area network but is not limited thereto. The network may be any form of shared resource network (SRN), i.e. in an SRN hardware resources are shared, and each hardware network element can be accessed from any other network element. An SRN in accordance with the present invention is more-or-less synonymous with a CAN, LAN or WAN, but the term SRN will be used to indicate that the present invention is not limited to specific aspects of known CAN's, WAN's or LAN's e.g. contention scheme or whether Ethernet, Token Ring or Wireless LAN. In particular, the present invention relates to a PAN—a personal area network, involving short-range radio connection between mobile units and master units. Also the topology of the PAN, LAN or WAN is not considered a limit on the present invention, e.g. bus physical, star physical, distributed star, ring physical, bus logical, ring logical may all be used as appropriate. Various types of wireless LAN have been standardized or are in general use, e.g. the standards IEEE 802.11, IEEE 802.11HR (Spread Spectrum) and systems based on DECT, Bluetooth, HIPERLAN. Wireless LAN's are discussed in detail in “Wireless LAN's” by Jim Geier, Macmillan Technical Publishing, 1999.

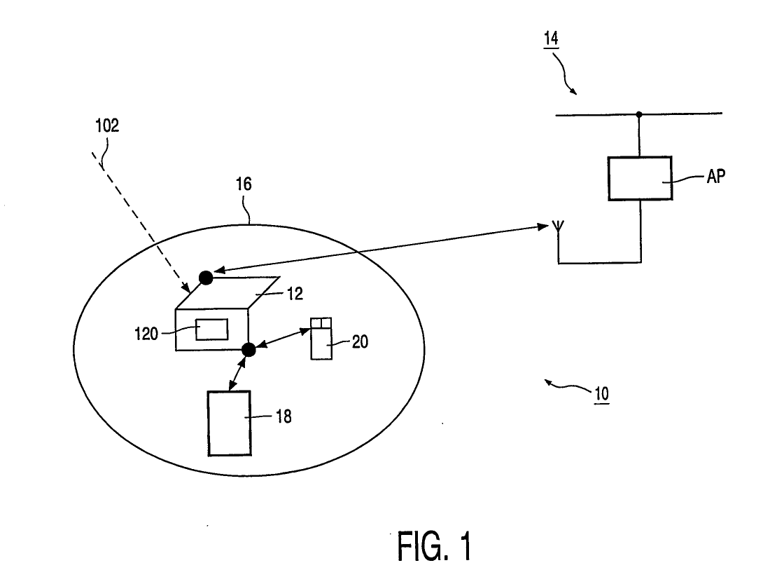

Referring now to the figures, and in particular for the moment to FIG. 1, a communications arrangement 10 involves at least a first client device such as a lap-top computer 12 which communicates selectively with a shared resources network, such as a local area network 14 by means of a first wireless communications standard, e.g. an IEEE 802.11b link. The communication is preferably performed without a wired connection and in the case of IEEE 802.11b using a WLAN-enabled access point AP.

Also within the communications arrangement 10 is available a second wireless communications standard, e.g. in the form of a Bluetooth network 16. The Bluetooth network 16 is available to the lap-top 12 for WPAN communications, for example with further client devices such as a personal digital assistant (PDA) 18 and/or an HID device such as a mouse 20. The Bluetooth network 16 may use the same access point AP as the IEEE 802.11b link, depending on range and WPAN enablement. It will be noted, however, that all the embodiments of the present invention can be used with the Bluetooth™ protocol. The features of such a system may include one or more of:
Slow frequency hopping as a spread spectrum technique;
Master and slave units whereby the master unit can set the hopping sequence;
Each device has its own clock and its own address;
The hopping sequence of a master unit can be determined from its address;
A set of slave units communicating with one master all have the same hopping frequency (of the master) and form a piconet;
Piconets can be linked through common slave units to form a scatternet;
Time Division Multiplex Transmissions (TDMA) between slave and master units;
Time Division Duplex (TDD) transmissions between slaves and masters units;
Transmissions between slave and master units may be either synchronous or asynchronous;
Master units determine when slave units can transmit;
Slave units may only reply when addressed by a master unit;
The clocks are free-running;
Uncoordinated networks, especially those operating in the 2.4 GHz license-free ISM band;
A software stack to enable applications to find other Bluetooth™ devices in the area;
Other devices are found by a discovery/inquiry procedure; and
Hard or soft handovers.

With regard to frequency hopping, “slow frequency hopping” refers to the hopping frequency being slower than the modulation rate, “fast frequency hopping” referring to a hopping rate faster than the modulation rate. The present invention is not limited to either slow or fast hopping.

As the laptop moves away from the network access point AP, the impact of or on such a co-located active Bluetooth (BT) piconet 16 may become severe. In fact, being 5 Mbps the maximum achievable throughput of an IEEE802.11b link operating at 11 Mbps between the network access point AP and the laptop 12, when the received signal strength at the laptop 12 is around −60 dBm, the throughput may decrease to 2 Mbps in the presence of traffic in the BT piconet 16. This may be verified for WLAN and WPAN antennas spaced apart by 25 cm and 0 dBm Bluetooth transmission power. To this end, the skilled man is referred to; Mobilan Corporation “Sim-Op™—Unleashing the Full Potential of Wi-Fi™ and Bluetooth Co-existence”, which can be found at:
http://www.mobilian.com/whitepaper_frame.htm

Depending on usage scenarios, the laptop 12 could coordinate operation of Bluetooth and IEEE802.11b to reduce throughput reduction if it could control both wireless interfaces at the same time. The problem is that, in many existing operating systems, such interfaces are independent of each other and cannot be easily coordinated. This is where the concepts involved in a Wireless Adaptation Layer (WAL) may be introduced in accordance with the present invention.

The laptop 12 of this embodiment is equipped with multi-standard wireless hardware, sometimes referred to as a combination or “combo” chipset, that supports multiple wireless communication standards and that can be controlled by a single software network interface. This software driver may be called a Wireless Adaptation Layer (WAL) and provides a uniform interface to the Internet Protocol (1P) layer for such functions as:
1. transmission of IP packets;
2. traffic shaping and control;
3. radio link monitoring and control;
4. paging of idle devices (e.g. client/mobile); and
5. handover between two access points AP, possibly using heterogeneous standards.

WAL is a wireless network driver that is designed to allow native Internet applications to be run transparently on client/mobile devices, e.g. without the need to change common transport protocols like TCP/IP or UDP/IP. A suitable set of basic design principles for WAL are described in: P. Mahonen et al. “Platform-Independent IP Transmission over Wireless Networks: The WINE Approach”, IEEE PCM, December 2001, where the focus is on boosting IP transport in homogeneous wireless networks. As the WAL of the present invention is adapted to support multiple wireless standards, it may be referred to for convenience as a Multi-standard WAL (M-WAL).

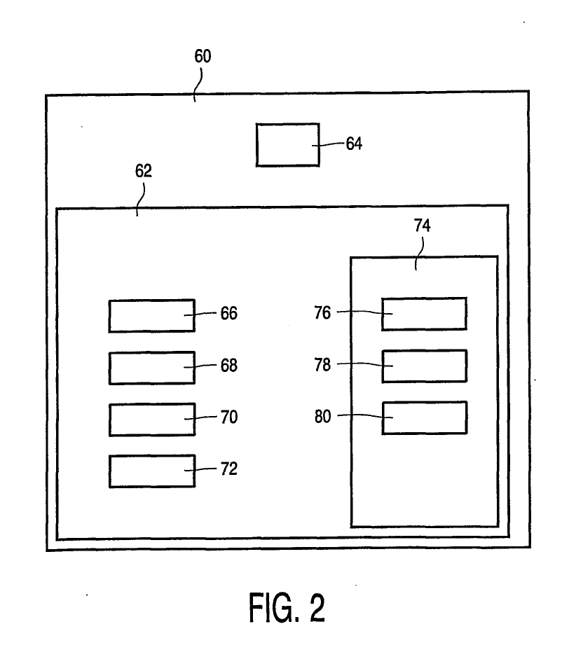

Referring now for the moment in particular to FIG. 2, Bluetooth profiles relevant to the present invention will be discussed. In Bluetooth, application scenarios are categorized into profiles, which describe how the Bluetooth standard must be used for a specific purpose, e.g. to exchange business cards between two devices or to send a fax. Profiles are hierarchical: all of them are based on a general access profile 60, while a significant number is based on a serial profile 62.

The serial profile 62 is implemented by the RFCOMM protocol, which fits above the L2CAP layer in the Bluetooth stack and is suited to point-to-point applications. PAN profile 64 is not based on the serial profile (RFCOMM), since it is intended to provide Ethernet network emulation for a BT piconet. Instead it uses the Bluetooth Network Encapsulation Protocol (BNEP) to encapsulate IP datagrams into Ethernet frames.

Further shown are dial-up 66, LAN Access 68, Fax 70, Headset 72, and Generic OBEX with Object Push 76, Synchronization 78, and File Transfer 80.

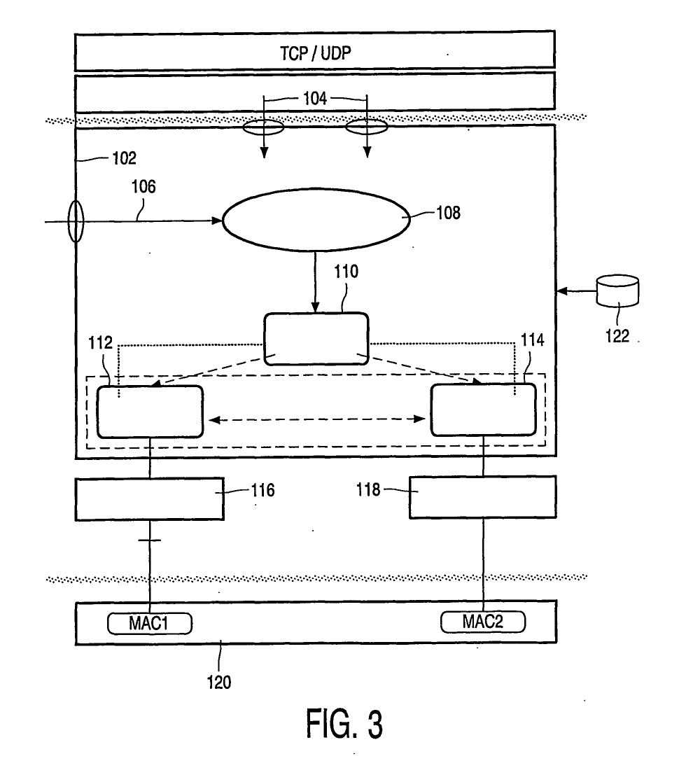

Referring also now to FIG. 3, the network structure 100 of the M-WAL 102 is depicted in the form of a software implemented virtual driver architecture. For networking-only purposes, the M-WAL 102 exports two Ethernet interfaces 104 to the operating system. For Bluetooth profiles other than PAN, then M-WAL 102 exports a serial interface 106 for use with profiles like OBEX, synchronization, file transfer and all profiles that are based on the serial profile.

WAL Coordinator 108

A WAL coordinator 108 controls the overall behavior of the M-WAL interface. The WAL coordinator 108 receives control information from all lower layer controllers and adapts the scheduling policy according to reported channel status or other parameters. Each packet received from the IP stack is classified in the WAL coordinator 108 by examining the header information of the upper layer protocols. Once classified, the packet to be transmitted is passed downstream to an M-WAL scheduler 110. The WAL coordinator also receives data to be transmitted by the serial interface 106 that the M-WAL 102 exports.

Controllers

The lower layer driver modules for WPAN and WLAN systems, called controllers 112, 114, are responsible for exchanging data packets and control messages with existing device drivers 116, 118. For example, in the case of WPAN, the related controller module 112 uses the Bluetooth Host Controller Interface (HCl) to vary link parameters, operating modes and the overall operation of the BT host controller. The WLAN controller 114 handles the transmission and reception of Ethernet frames and sets the available parameters of the existing IEEE 802.11 driver (fragmentation, RTS/DTS, modulation). M-WAL controllers 112, 114 perform the following functions:
Initialization of the lower layers of the baseband processor(s);
exchanging data frames as well as control messages with the multi-standard hardware 120 (e.g. combination chipset) according to the specific interface;
managing the establishment of connections when necessary,
managing the low-power modes of the wireless transceiver (e.g. radio) when available; and
monitoring the wireless channel quality and making it available to the WAL coordinator 108.
   Scheduler 110

A significant component in the M-WAL is the packet scheduler 110, which receives packets to transmit either by the serial interface 106 or by the two Ethernet interfaces 104. Based on information from the WAL coordinator 108, the scheduler 110 may adopt different strategies to avoid the possibility of Bluetooth and IEEE802.11b transmitting at the same time using the same frequency. In the following section, coexistence policies to be adopted in the M-WAL scheduler are outlined.

Driver Level Switching

As introduced above, a scheduling policy can be enforced in the M-WAL packet scheduler 110. One example of such policy is a simple time sharing mechanism where a fixed percentage of time is dedicated to WPAN and the rest to WLAN. The duty cycle can then be dynamically varied according to knowledge of traffic characteristics. For example, when it is known that WPAN is not active, the whole percentage of time can be given to WLAN. This technique only applies to the transmission phase and requires that lower layer delays encountered by the packet be taken into account.

Traffic Shaping

A Quality of Service (QoS) module inside the M-WAL 102 can be used to schedule the transmission of IP packets according to application requirements. In the simplest case, the QoS module can give priority to UDP packets over TCP packets based on the classification performed by the WAL coordinator 108. For example, when traffic in the BT piconet must be given priority, TCP connections in the WLAN link can be delayed by means of buffering.

Modifications to MAC Schedulers

The preferred solution is to act at MAC level: the IEEE 802.11 scheduler 114 and Bluetooth scheduler 112 should communicate, so each one knows when the channel is taken by a packet from the other one, and refrains from transmitting.

This technique is often referred to as Packet Traffic Arbitration (PTA) and its description can be found in IEEE P802.15.2 Draft Recommended Practice for Information Technology Part 15.2: “Coexistence of Wireless Personal Area Networks with Other Wireless Devices Operating in Unlicensed Frequency Bands” (see http://www.ieee802.org/15/pub/TG2.html). When the channel is free again, an agreement must be found between the schedulers 114, 112 about which one should be transmitting a packet. The decision could be taken according to queued packet QoS requirements, and duration of the channel occupation. The M-WAL 102 can set policies for both schedulers 120 by using channel state and traffic information This embodiment may require changes in the MAC schedulers 120, further indicated by MAC1 and MAC2, but standards compliance can be maintained.

Use of Disjoint Bands

Bluetooth can use a reduced band, 2454-2477 MHz. This has been considered for countries like France and Spain, where part of the band typically used by Bluetooth is reserved. The Bluetooth portion of the hardware can use the reduced band (this can be performed by altering the country code: standard HCl commands only allow it to be read, however a proprietary HCl command for setting it should preferably be implemented), and 802.11 can use a channel that does not overlap with it. This obviously cannot currently be used in France and Spain. Also, the Bluetooth band reduction could be higher than needed (since the saved band is enough for allocating 2 non-overlapping 802.11 channels), thus possibly causing inefficient use of the band.

Packet Fragmentation

In 802.11 and in Bluetooth, if there are errors on a packet, the whole packet is retransmitted. This is bad for noisy channels (and Bluetooth interference can be considered as noise), because a few errors on a long packet can cause the retransmission of the whole packet. 802.11 and Bluetooth systems allow controllable packet fragmentation: each packet is split in smaller fragments, and an error causes the retransmission of that fragment only. Also, each system occupies the channel for shorter slices of time, thus allowing for a fairer use of the band. A drawback is that overhead is added for each fragment. This technique is already implemented in some existing drivers. However, the M-WAL 102 can activate this mode only when it is needed, according to its knowledge of traffic characteristics. In similar fashion, dynamic control of other parameters such as output power variation and variation of data rate may be applied by M-WAL 102 only when required. A configuration file 122 is preferably provided that contains the functional parameters of the Wireless Adaptation Layer and can be managed by a dedicated tool, where for example relevant parameters may be controlled by the user.

Avoidance Of Interference From Other Bands

Taking for the moment the present embodiment, the above solutions may only apply to interference between co-located Bluetooth and 802.11 devices. But a nearby Bluetooth device belonging to another piconet could also interfere with 802.11. Also, the hardware scheduler 110 and software driver solutions may only apply to Bluetooth masters, because they can choose when to transmit packets, while a slave must transmit packets when a master asks them to do so, and they have to do so in the slot immediately after the one in which they received the request. A possible solution to interference due to nearby Bluetooth devices could be to implement 802.11 collision avoidance in Bluetooth hardware or firmware. When an 802.11 device transmits a Ready To Send packet, all Bluetooth masters that receive it should refrain from transmitting, so as not to interfere with the 802.11 packet. If the local Bluetooth device is a slave, the Bluetooth masters should include the local device's master. This should be implemented on Bluetooth chips, and since it is a non-standard extension it may not be supported by nearby Bluetooth transmitters.

The present invention falls within the category of solutions implemented by driver level switching. The improvements to the art include implementation of a co-existence arrangement in the protocol architecture in the form of a joint device driver able to control multiple wireless transceivers, without requiring ad-hoc design of custom hardware and software for controlling such custom hardware. The solution can be applied to any electronic device equipped with IEEE 802.11 and Bluetooth technologies, although not limited thereto and is available to also manage and coordinate hardware and software associated with other wireless standards, e.g. others sharing the same bandwidth such as ZigBEE. No assumptions are made regarding hardware suppliers and/or associated drivers. The technique disclosed therefore avoids major modifications in the MAC layers and provides a solution for the many legacy devices that cannot easily be upgraded to support the same coexistence features that may be introduced in accordance with some existing proposals, such as those requiring custom hardware designed specifically to enable co-existence. Furthermore, the architecture of the present invention introduces new features that cannot be found in the prior art, such as considering also the characteristics of the traffic generated by the applications. The queuing policies applied to packets ensure that the IEEE 802.11 and Bluetooth wireless transceivers do not transmit at the same time, while the QoS parameters are also taken into account so as to enable co-existence without deteriorating the performance of upper layers.

Foreseen embodiments for the present invention disclosure include both a client device, such as a laptop having BT interfaces and 802.11b WLAN connection as discussed in the specific but non-limiting example given, but may also include other embodiments such as a multi-standard WLAN/BT wireless access point AP. In this manner, the general WAL framework is extended to allow an equipped device, whether for example a mobile device or a fixed device such as an access point AP, to manage concurrent operation of a plurality of wireless standards in for example the ISM band. The co-existence is achieved in such a manner that mutual interference is reduced and degradation of throughput is consequently limited.

While the present invention has been particularly shown and described with respect to a preferred embodiment, it will be understood by those skilled in the art that changes in form and detail may be made without departing from the scope and spirit of the invention.

Glossary

| | |
|---|---|
| HCI | Host Controller Interface |
| HID | Human Interface Device |
| IEEE | Institute of Electrical and Electronics Engineers |
| IETF | Internet Engineering Task Force |
| ISM | Instrumental Scientific Medical |
| IP | Internet Protocol |
| L2CAP | Logical Link Control and Adaptation Protocol |
| LAN | Local Area Network |
| LLCT | Logical Link Control Translator |
| LOP | Link Outage Protection |
| MAC | Medium Access Control |
| MT | Mobile Terminal |
| M-WAL | Multi-standard WAL |
| OBEX | Object Exchange |
| PAN | Personal Area Network |
| QoS | Quality of Service |
| RFCOMM | Serial port Emulation Protocol |
| SIG | Special Interest Group |
| TCP | Transmission Control Protocol |
| UDP | User Datagram Protocol |
| WAL | Wireless Adaptation Layer |
| WLAN | Wireless Local Area Network |
| WPAN | Wireless Personal Area Network |

1. A device incorporating a first wireless communications arrangement adapted to operate in accordance with a first communications standard and a second wireless communications arrangement adapted to operate in accordance with a second communications standard, at least a portion of a range of operation according to said first and second communications standards being in use in an overlapping relationship, said device having a protocol architecture including at least one of software implemented driver-level switching and dynamic parameter control adapted to ensure that there is substantially no mutual interference between communications at said device under either of said first and second communications standards.

2. A device according to claim 1, wherein said driver level switching avoids said mutual interference through the application of a scheduling policy to transmissions under each said communications standard.

3. A device according to claim 2, wherein said scheduling policy is adapted to place said transmissions in a queue and to control said queue such that transmissions under one of said communications standards do not collide with transmissions under the other communications standard.

4. A device according to claim 2, wherein said scheduling policy comprises a time-share mechanism adapted to apply predetermined percentages of time to transmissions made under each said communications standard.

5. A device according to claim 2, wherein a duty cycle of said scheduling policy is dynamically varied according to the characteristics of communications traffic under each said standard.

6. A device according to claim 1, wherein said communications standards comprise wireless communications standards and said software is implemented in the form of a wireless adaptation layer.

7. A device according to claim 1, wherein said software further comprises a quality-of-service arrangement adapted to schedule transmission under said communications standards according to application requirements.

8. A device according to claim 1, wherein schedulers of each communications standard communicate, such that each one knows when a channel is taken by a communication from the other and refrains from transmitting, said schedulers preferably communicating at Medium Access Control (MAC) level.

9. A device according to claim 8, wherein policies for said schedulers are set in accordance with channel state or traffic information.

10. A device according to claim 1, wherein communications under a said standard are performed at least temporarily using a reduced bandwidth, such that communications under the other said standard substantially do not overlap.

11. A device according to claim 1, wherein said communications comprise packet transmissions.

12. A device according to claim 1; wherein said communications standards comprise Bluetooth and IEEE 802.11.

13. A device according to claim 12, wherein an operating parameter, such as one or more of packet fragmentation, variable transmission power and variable data rate, is activated by said software only when it is determined that it is required, such determination preferably being based on traffic characteristics.

14. A device according to claim 12, wherein collision avoidance between said communications standards is implemented in Bluetooth hardware or firmware.

15. A device according to claim 1, wherein said device comprises one of a client device, a master unit, a slave unit or an access point.

16. A method of implementing co-existence of a plurality of wireless communications arrangements operating under communications standards having at least partially overlapping bandwidths, the method including implementing, in software at driver level in a protocol stack, a driver level switching arrangement adapted to ensure that there is substantially no mutual interference between communications under said communications standards.

17. A software product having encoded thereon executable code for implementing co-existence of a plurality of wireless communications arrangements operating under communications standards having at least partially overlapping bandwidths, the software product including code for implementing, at driver level in a protocol stack, a driver level switching arrangement adapted to ensure that there is substantially no mutual interference between communications under said communications standards.
